(19) United States
(12) Patent Application Publication
(10) Pub. No.: US 2025/0365765 A1
(43) Pub. Date: Nov. 27, 2025

(54) METHOD AND APPARATUS FOR RECOVERING ERRORS IN WIRELESS LAN

(71) Applicants: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(72) Inventors: Yong Ho Kim, Incheon (KR); Ju Seong Moon, Osan-si, Gyeonggi-do (KR)

(73) Assignees: HYUNDAI MOTOR COMPANY, Seoul (KR); KIA CORPORATION, Seoul (KR); Korea National University of Transportation Industry-Academic Cooperation Foundation, Chungju-si, Chungcheongbuk-do (KR)

(21) Appl. No.: 18/874,737

(22) PCT Filed: Sep. 5, 2023
(86) PCT No.: PCT/KR2023/013271

§ 371 Date: Dec. 13, 2024

(30) Foreign Application Priority Data
Sep. 8, 2022 (KR) 10-2022-0114305

(51) Int. Cl. H04W 74/0816; H04W 74/08; H04W 80/02

(52) U.S. Cl. CPC H04W 74/0816; H04W 74/0866; H04W 80/02

(57) ABSTRACT

Disclosed are a method and apparatus for recovering errors in a wireless LAN. This method performed by a STA MLD comprises the steps of: transmitting, by a first STA linked with the STA MLD, a first frame to a first AP linked with an AP MLD on a first link; transmitting, by a second STA linked with the STA MLD, a second frame to a second AP linked with the AP MLD on a second link; if the transmission of the first frame fails, retransmitting, by the first STA, the first frame to the first AP on the first link; and receiving, from the first AP, a first reception response frame for the first frame on the first link.

### TECHNICAL FIELD

The present disclosure relates to a wireless local area network (LAN) communication technique, and more particularly, to a technique for recovering errors of a frame in communication of a non-simultaneous transmit and receive (NSTR) device.

### BACKGROUND ART

Recently, as the spread of mobile devices expands, a wireless local area network technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards that use wireless LAN technology are mainly developed as the Institute of Electrical and Electronics Engineers (IEEE) 802.11 standards. As the aforementioned wireless LAN technology has been developed and widely adopted, applications utilizing wireless LAN technology have diversified, and demand has arisen for wireless LAN technology that supports a higher throughput.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

In a wireless LAN, improvements to a carrier sensing multiple access with collision avoidance (CSMA/CA) scheme may be necessary for low-power operations. When the CSMA/CA scheme is used, a communication node (e.g., AP, station (STA), multi-link device (MLD)) can perform a channel access operation to transmit data. If a result of the channel access operation indicates an idle state, the communication node can transmit data. Therefore, the communication node may compete with other communication nodes to transmit data. Since time is consumed due to competition, data may not be transmitted promptly. In other words, the requirements for low-latency communication may not be satisfied.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure is directed to providing a method and an apparatus for recovering errors of a frame in communication of a non-simultaneous transmit and receive (NSTR) device.

### Technical Solution

A method of a station (STA) multi-link device (MLD), according to exemplary embodiments of the present disclosure for achieving the above-described objective, may comprise: allowing a first STA affiliated with the STA MLD to transmit a first frame to a first access point (AP) affiliated with an AP MLD on a first link; allowing a second STA affiliated with the STA MLD to transmit a second frame to a second AP affiliated with the AP MLD on a second link; in response a transmission failure of the first frame, allowing the first STA to retransmit the first frame to the first AP on the first link; and receiving, from the first AP, a first reception response frame for the first frame on the first link, wherein the first reception response frame may include first reception status information of the first frame and second reception status information of the second frame.

The STA MLD may be a non-simultaneous transmit and receive (NSTR) STA MLD that does not support simultaneous transmit and receive (STR) operations, and when retransmission of the first frame causes interference in reception of a second reception response frame for the second frame, the second reception status information may be included in the first reception response frame.

The first reception response frame may include a first medium access control (MAC) layer protocol data unit (MPDU) including the first reception status information and a second MPDU including the second reception status information.

Transmission of the first frame and transmission of the second frame may be performed simultaneously, and a transmission end time of the first frame may be earlier than a transmission end time of the second frame.

Transmission of the first frame may be performed in a first transmit opportunity (TXOP) configured by the first STA, and transmission of the second frame may be performed in a second TXOP configured by the second STA.

The method may further comprise: allowing the second STA to receive a second reception response frame for the second frame from the second AP on the second link, after the retransmission operation of the first frame ends on the first link.

A method of an access point (AP) MLD, according to exemplary embodiments of the present disclosure for achieving the above-described objective, may comprise: allowing a first AP affiliated with the AP MLD to transmit a first frame to a first station (STA) affiliated with a STA MLD on a first link; allowing a second AP affiliated with the AP MLD to transmit a second frame to a second STA affiliated with the STA MLD on a second link; in response to a transmission failure of the first frame, allowing the first AP to retransmit the first frame to the first STA on the first link; and receiving, from the first STA, a first reception response frame for the first frame on the first link, wherein the first reception response frame may include first reception status information of the first frame and second reception status information of the second frame.

The STA MLD may be a non-simultaneous transmit and receive (NSTR) STA MLD that does not support simultaneous transmit and receive (STR) operations, and when transmission of a second reception response frame for the second frame causes interference in reception of the first frame, the second reception status information may be included in the first reception response frame.

The first reception response frame may include a first medium access control (MAC) layer protocol data unit (MPDU) including the first reception status information and a second MPDU including the second reception status information.

Transmission of the first frame and transmission of the second frame may be performed simultaneously, and a transmission end time of the first frame may be earlier than a transmission end time of the second frame.

Transmission of the first frame may be performed in a first transmit opportunity (TXOP) configured by the first STA, and transmission of the second frame may be performed in a second TXOP configured by the second STA.

The method may further comprise: allowing the second AP to receive a second reception response frame for the second frame from the second STA on the second link, after the retransmission operation of the first frame ends on the first link.

### Advantageous Effects

According to the present disclosure, considering a multi-link operation of a non-simultaneous transmit and receive (NSTR) device, transmissions that interfere with a reception operation of the NSTR device may not be performed. Through this operation, the reception operation of the NSTR device can be effectively performed. If an error occurs in data, the NSTR device can quickly recover from the error of data. Therefore, the reliability of data transmission can be improved, and transmission latency can be reduced.

### DESCRIPTION OF DRAWINGS

FIG. 1 is a block diagram illustrating a first exemplary embodiment of a communication node constituting a wireless LAN system.

FIG. 2 is a conceptual diagram illustrating a first exemplary embodiment of a multi-link configured between multi-link devices (MLDs).

FIG. 3A is a timing diagram illustrating a first exemplary embodiment of an error recovery method in multi-link transmission for an NSTR device.

FIG. 3B is a timing diagram illustrating a second exemplary embodiment of an error recovery method in multi-link transmission of an NSTR device.

FIG. 4A is a timing diagram illustrating a third exemplary embodiment of an error recovery method in multi-link transmission of an NSTR device.

FIG. 4B is a timing diagram illustrating a fourth exemplary embodiment of an error recovery method in multi-link transmission of an NSTR device.

FIG. 5A is a timing diagram illustrating a fifth exemplary embodiment of an error recovery method in multi-link transmission of an NSTR device.

FIG. 5B is a timing diagram illustrating a sixth exemplary embodiment of an error recovery method in multi-link transmission of an NSTR device.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

In the following, a wireless communication system to which exemplary embodiments according to the present disclosure are applied will be described. The wireless communication system to which the exemplary embodiments according to the present disclosure are applied is not limited to the contents described below, and the exemplary embodiments according to the present disclosure can be applied to various wireless communication systems. A wireless communication system may be referred to as a ‘wireless communication network’.

In exemplary embodiments, ‘configuration of an operation (e.g., transmission operation)’ may mean that ‘configuration information (e.g., information element(s), parameter(s)) for the operation’ and/or ‘information indicating to perform the operation’ is signaled. ‘Configuration of an information element (e.g., parameter)’ may mean that the information element is signaled. ‘Configuration of a resource (e.g., resource region)’ may mean that setting information of the resource is signaled.

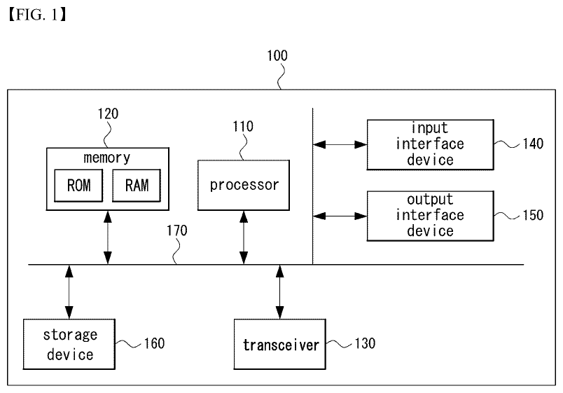

FIG. 1 is a block diagram illustrating a first exemplary embodiment of a communication node constituting a wireless LAN system.

As shown in FIG. 1, a communication node 100 may be an access point, a station, an access point (AP) multi-link device (MLD), or a non-AP MLD. An access point may refer to ‘AP’, and a station may refer to ‘STA’ or ‘non-AP STA’. An operating channel width supported by an AP may be 20 megahertz (MHz), 80 MHz, 160 MHz, or the like. An operating channel width supported by a STA may be 20 MHz, 80 MHz, or the like.

The communication node 100 may include at least one processor 110, a memory 120, and a transceiver 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The respective components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, and the storage device 160 through a dedicated interface.

The processor 110 may execute program commands stored in at least one of the memory 120 and the storage device 160. The processor 110 may refer to a central processing unit (CPU), a graphics processing unit (GPU), or a dedicated processor on which the methods according to the exemplary embodiments of the present disclosure are performed. Each of the memory 120 and the storage device 160 may be configured as at least one of a volatile storage medium and a nonvolatile storage medium. For example, the memory 120 may be configured with at least one of a read only memory (ROM) and a random access memory (RAM).

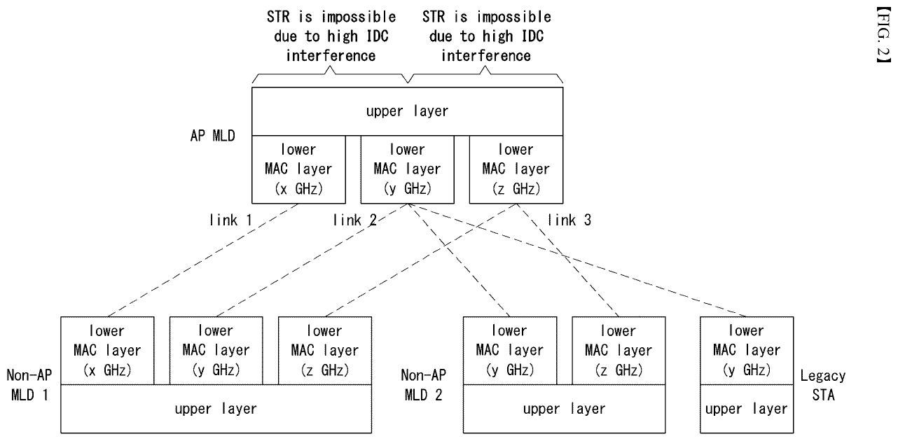

FIG. 2 is a conceptual diagram illustrating a first exemplary embodiment of a multi-link configured between multi-link devices (MLDs).

As shown in FIG. 2, an MLD may have one medium access control (MAC) address. In exemplary embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) affiliated with the non-AP MLD may have different MAC addresses. Each of the APs having different MAC addresses within the AP MLD may be in charge of each link, and may perform a role of an independent AP.

Each of the STAs having different MAC addresses within the non-AP MLD may be in charge of each link, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In exemplary embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 40 MHz bandwidth according to a channel expansion scheme (e.g., bandwidth expansion scheme) in a 2.4 GHz band, and perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, each link may be referred to as a link 1, a link 2, a link 3, or the like. A link number may be set by an access point, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between a link 1 and a link 2 in the frequency domain) is sufficient, the MLD may be able to perform an STR operation. For example, the MLD may transmit a physical layer convergence procedure (PLCP) protocol data unit (PPDU) 1 using the link 1 among multiple links, and may receive a PPDU 2 using the link 2 among multiple links. On the other hand, if the MLD performs an STR operation when the band separation between multiple links is not sufficient, in-device coexistence (IDC) interference, which is interference between the multiple links, may occur. Accordingly, when the bandwidth separation between multiple links is not sufficient, the MLD may not be able to perform an STR operation. A link pair having the above-described interference relationship may be a non-simultaneous transmit and receive (NSTR)-limited link pair. Here, the MLD may be referred to as ‘NSTR AP MLD’ or ‘NSTR non-AP MLD’.

For example, a multi-link including a link 1, a link 2, and a link 3 may be configured between an AP MLD and a non-AP MLD 1. When a band separation between the link 1 and the link 3 is sufficient, the AP MLD may perform an STR operation using the link 1 and the link 3. That is, the AP MLD may transmit a frame using the link 1 and receive a frame using the link 3. When a band separation between the link 1 and the link 2 is insufficient, the AP MLD may not be able to perform an STR operation using the link 1 and the link 2. When a band separation between the link 2 and the link 3 is not sufficient, the AP MLD may not be able to perform an STR operation using the link 2 and the link 3.

Meanwhile, in a wireless LAN system, a negotiation procedure for a multi-link operation may be performed in an access procedure between a station and an access point. A device (e.g., access point, station) that supports multiple links may be referred to as ‘multi-link device (MLD)’. An access point supporting multiple links may be referred to as ‘AP MLD’, and a station supporting multiple links may be referred to as ‘non-AP MLD’ or ‘STA MLD’. The AP MLD may have a physical address (e.g., MAC address) for each link. The AP MLD may be implemented as if an AP in charge of each link exists separately. A plurality of APs may be managed within one AP MLD. Therefore, coordination between a plurality of APs belonging to the same AP MLD may be possible. A STA MLD may have a physical address (e.g., MAC address) for each link. The STA MLD may be implemented as if a STA in charge of each link exists separately. A plurality of STAs may be managed within one STA MLD. Therefore, coordination between a plurality of STAs belonging to the same STA MLD may be possible.

For example, an API of the AP MLD and a STA1 of the STA MLD may each be responsible for a first link and perform communication using the first link. An AP2 of the AP MLD and a STA2 of the STA MLD may each be responsible for a second link and perform communication using the second link. The STA2 may receive status change information for the first link on the second link. In this case, the STA MLD may collect information (e.g., status change information) received on the respective links, and control operations performed by the STA1 based on the collected information.

Hereinafter, data transmission and reception methods in a wireless LAN system will be described. Even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a STA is described, an AP corresponding thereto may perform an operation corresponding to the operation of the STA. Conversely, when an operation of an AP is described, a STA corresponding thereto may perform an operation corresponding to the operation of the AP.

In exemplary embodiments, operations of a STA may be interpreted as operations of a STA MLD, operations of a STA MLD may be interpreted as operations of a STA, operations of an AP may be interpreted as operations of an AP MLD, and operations of an AP MLD may be interpreted as operations of an AP. A STA of a STA MLD may refer to a STA affiliated with the STA MLD, and an AP of an AP MLD may refer to an AP affiliated with the AP MLD. When a STA MLD includes a first STA operating on a first link and a second STA operating on a second link, operations of the STA MLD on the first link may be interpreted as operations of the first STA, and operations of the STA MLD on the second link may be interpreted as operations of the second STA. When an AP MLD includes a first AP operating on the first link and a second AP operating on the second link, operations of the AP MLD on the first link may be interpreted as operations of the first AP, and operations of the AP MLD on the second link may be interpreted as operations of the second AP. In exemplary embodiments, a transmission time of a frame may refer to a transmission start time or a transmission end time, and a reception time of a frame may refer to a reception start time or a reception end time. A transmission time may be interpreted as corresponding to a reception time. A time point may be interpreted as a time, and a time may be interpreted as a time point.

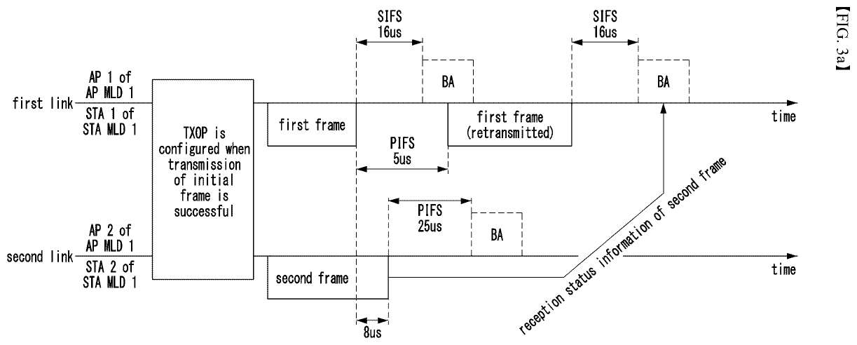

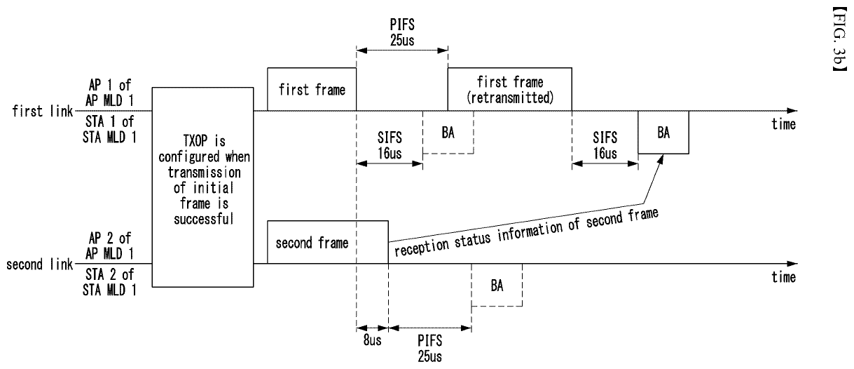

FIG. 3A is a timing diagram illustrating a first exemplary embodiment of an error recovery method in multi-link transmission for an NSTR device.

As shown in FIG. 3A, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The STA 1 may perform initial transmission of a frame (e.g., data frame, uplink frame) on a first link and may receive a response frame for the frame. Through the transmission operation of the frame, the STA 1 may configure a transmit opportunity (TXOP) on the first link. In other words, a TXOP may be granted to the STA 1, and the STA 1 may be a TXOP holder. The STA 2 may perform initial transmission of a frame (e.g., data frame, uplink frame) on the second link and may receive a response frame for the frame. Through the transmission operation of the frame, the STA 2 may configure a TXOP on the second link. In other words, a TXOP may be granted to the STA 2, and the STA 2 may be a TXOP holder. In the present disclosure, a frame may refer to a physical layer protocol data unit (PPDU), a MAC layer protocol data unit (MPDU), or an aggregated (A)-MPDU. A response frame may be an acknowledgment (ACK) frame or a block ACK (BA) frame.

Frame transmission may be performed multiple times within the TXOP. In other words, if the initial transmission of the frame is successful, the STA 1 and STA 2 may perform multiple frame transmissions within the TXOP. A time difference between an end time of a first frame transmitted by the STA 1 on the first link and an end time of a second frame transmitted by the STA 2 on the second link may be up to 8 μs. The end time of the first frame transmitted by the STA 1 on the first link may be earlier than the end time of the second frame transmitted by the STA 2 on the second link.

The STA 1 may transmit the first frame on the first link, and may not receive a reception response frame (e.g., BA frame) within a preset time (e.g., priority interframe space (PIFS)) from a transmission time of the first frame. In other words, the transmission of the first frame may fail. Since the STA 1 is a TXOP holder, the STA 1 may perform a PIFS recovery operation and perform a retransmission operation of the first frame.

The AP MLD 1 may identify that the reception operation of the first frame on the first link is completed before the reception operation of the second frame on the second link. In this case, an AP 2 may transmit a reception response frame for the second frame after a preset time (e.g., PIFS) from a reception end time of the second frame on the second link. While the AP 2 is waiting for the preset time (e.g., PIFS) to transmit the reception response frame for the second frame, the STA 1 may perform a retransmission operation of the first frame on the first link. An AP 1 may receive the first frame (e.g., the retransmitted frame) from the STA 1. In this situation, if the AP 2 transmits the reception response frame on the second link, since the STA MLD 1 operates on an NSTR link pair, the STA 2 may not be able to receive the reception response frame for the second frame on the second link due to the retransmission of the first frame on the first link. In other words, the retransmission of the first frame on the first link may interfere with the reception of the reception response frame for the second frame on the second link.

Therefore, while the retransmission operation of the STA 1 on the first link (e.g., the retransmission operation of the first frame) is being performed, the AP 2 may not transmit the reception response frame for the second frame on the second link. If the AP 2 does not transmit the reception response frame on the second link, the AP MLD 1 may notify a reception status of the second frame based on one or more of the following methods.

### (Method 1)

The AP MLD 1 may notify a reception status of the second frame using a reception response frame for the first frame retransmitted by the STA 1. For example, the AP MLD 1 (e.g., AP 1) may generate a reception response frame that includes reception status information for the first frame retransmitted on the first link and reception status information for the second frame on the second link, and transmit the reception response frame on the first link in response to the retransmitted first frame. The reception status of the first frame and the reception status of the second frame may be indicated by the single reception response frame. Alternatively, a first reception response frame indicating the reception status of the first frame and a second reception response frame indicating the reception status of the second frame may be generated, and a single reception response frame including both the first and second reception response frames may be generated. The single reception response frame may have a form of an A-MPDU. In other words, the reception response frame may include a first MPDU including the reception status information of the first frame and a second MPDU including the reception status information of the second frame.

### (Method 2)

The AP 2 of the AP MLD 1 may suspend transmission of the reception response frame for the second frame until the retransmission operation of the first frame of the STA 1 is completed. After the completion of the retransmission operation of the first frame of the STA 1, the AP 2 may perform a channel access operation (e.g., backoff operation) on the second link before transmitting the reception response frame for the second frame. Alternatively, after the completion of the retransmission operation of the first frame by the STA 1, the AP 2 may transmit the reception response frame for the second frame on the second link without performing a channel access operation. Alternatively, the AP 2 may transmit the reception response frame for the second frame after a preset time (e.g., short interframe space (SIFS), PIFS, extended interframe space (EIFS), distributed coordination function (DCF) interframe space (DIFS), or arbitrary interframe space (AIFS)) from a completion time of the retransmission operation of the first frame of the STA 1.

One of (Method 1) or (Method 2) may be used. Alternatively, (Method 1) and (Method 2) may be performed together. For example, based on (Method 1), the reception response frame including the reception status information of the first retransmission frame and the reception status information of the second frame may be transmitted and received on the first link. Additionally, based on (Method 2), the reception response frame for the second frame may be transmitted and received on the first link after the completion of the retransmission operation of the first frame.

On the first link, the STA 1 may not perform the retransmission operation of the first frame based on the PIFS recovery operation. If the retransmission operation of the first frame is not performed on the first link, the AP 2 may transmit, on the second link, the reception response frame for the second frame after a preset time (e.g., PIFS or SIFS) from a reception time of the second frame.

FIG. 3B is a timing diagram illustrating a second exemplary embodiment of an error recovery method in multi-link transmission of an NSTR device.

As shown in FIG. 3B, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The AP 1 may perform initial transmission of a frame (e.g., data frame, downlink frame) on the first link and may receive a reception response frame for the frame. Through the transmission operation of the frame, the AP 1 may configure a TXOP on the first link. In other words, a TXOP may be granted to the AP 1, and the AP 1 may be a TXOP holder. The AP 2 may perform initial transmission of a frame (e.g., data frame, downlink frame) on the second link and may receive a reception response frame for the frame. In other words, a TXOP may be granted to the AP 2. Through the transmission operation of the frame, the AP 2 may configure the TXOP on the second link, and the AP 2 may be a TXOP holder.

Frame transmission may be performed multiple times within the TXOP. In other words, if the initial transmission of the frame is successful, the AP 1 and AP 2 may perform multiple frame transmissions within the TXOP. A time difference between an end time of a first frame transmitted by the AP 1 on the first link and an end time of a second frame transmitted by the AP 2 on the second link may be up to 8 us. The end time of the first frame transmitted by the AP 1 on the first link may be earlier than the end time of the second frame transmitted by the AP 2 on the second link.

The AP 1 may transmit the first frame on the first link and may not receive a reception response frame (e.g., BA frame) for a preset time (e.g., PIFS) from a transmission time of the first frame. In other words, the transmission of the first frame may fail. Since the AP 1 is a TXOP holder, the AP 1 may perform a PIFS recovery operation and perform a retransmission operation of the first frame.

The STA MLD 1 may identify that the reception operation of the first frame on the first link is completed before the reception operation of the second frame on the second link. In this case, the STA 2 may transmit a reception response frame for the second frame after a preset time (e.g., PIFS) from a reception end time of the second frame on the second link. While the STA 2 is waiting for the preset time (e.g., PIFS) to transmit the reception response frame for the second frame, the AP 1 may perform the retransmission operation of the first frame on the first link. The STA 1 may receive the first frame (e.g., the retransmitted frame) from the AP 1. In this situation, if the STA 2 transmits the reception response frame on the second link, since the STA MLD 1 operates on an NSTR link pair, the transmission of the reception response frame of the STA 2 may cause interference in reception of the first frame retransmitted by the AP 1. A reception error of the retransmitted first frame may occur.

Therefore, while the retransmission operation of the AP 1 on the first link (e.g., the retransmission operation of the first frame) is being performed, the STA 2 may not transmit the reception response frame for the second frame on the second link. If the STA 2 does not transmit the reception response frame on the second link, the STA MLD 1 may notify a reception status of the second frame based on one or more of the following methods.

### (Method 1)

The STA MLD 1 may notify a reception status of the second frame using a reception response frame for the first frame retransmitted by the AP 1. For example, the STA MLD 1 (e.g., STA 1) may generate a reception response frame that includes reception status information for the first frame retransmitted on the first link and reception status information for the second frame on the second link, and transmit the reception response frame on the first link in response to the retransmitted first frame. The reception status of the first frame and the reception status of the second frame may be indicated by the single reception response frame. Alternatively, a first reception response frame indicating the reception status of the first frame and a second reception response frame indicating the reception status of the second frame may be generated, and a single reception response frame including both the first and second reception response frames may be generated. The single reception response frame may have a form of an A-MPDU. In other words, the reception response frame may include a first MPDU including the reception status information of the first frame and a second MPDU including the reception status information of the second frame.

### (Method 2)

The STA 2 of the STA MLD 1 may suspend transmission of the reception response frame for the second frame until the retransmission operation of the first frame of the AP 1 is completed. After the completion of the retransmission operation of the first frame of the AP 1, the STA 2 may perform a channel access operation (e.g., backoff operation) on the second link before transmitting the reception response frame for the second frame. Alternatively, after the completion of the retransmission operation of the first frame by the AP 1, the STA 2 may transmit the reception response frame for the second frame on the second link without performing a channel access operation. Alternatively, the STA 2 may transmit the reception response frame for the second frame after a preset time (e.g., SIFS, PIFS, EIFS, DIFS, or AIFS) from a completion time of the retransmission operation of the first frame of the AP 1.

One of (Method 1) or (Method 2) may be used. Alternatively, (Method 1) and (Method 2) may be performed together. For example, based on (Method 1), the reception response frame including the reception status information of the first retransmission frame and the reception status information of the second frame may be transmitted and received on the first link. Additionally, based on (Method 2), the reception response frame for the second frame may be transmitted and received on the first link after the completion of the retransmission operation of the first frame.

On the first link, the AP 1 may not perform the retransmission operation of the first frame based on the PIFS recovery operation. If the retransmission operation of the first frame is not performed on the first link, the STA 2 may transmit, on the second link, the reception response frame for the second frame after a preset time (e.g., PIFS or SIFS) from a reception time of the second frame.

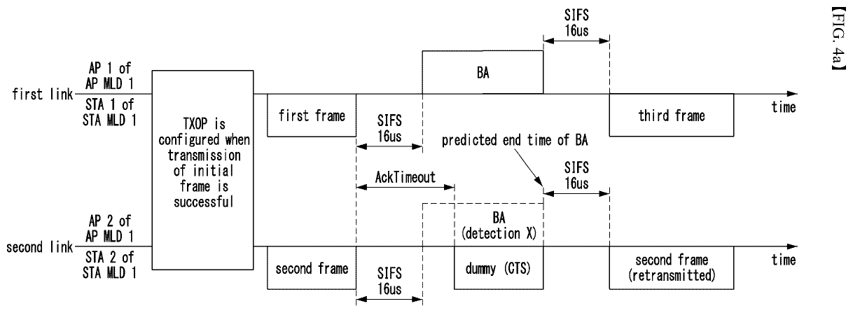

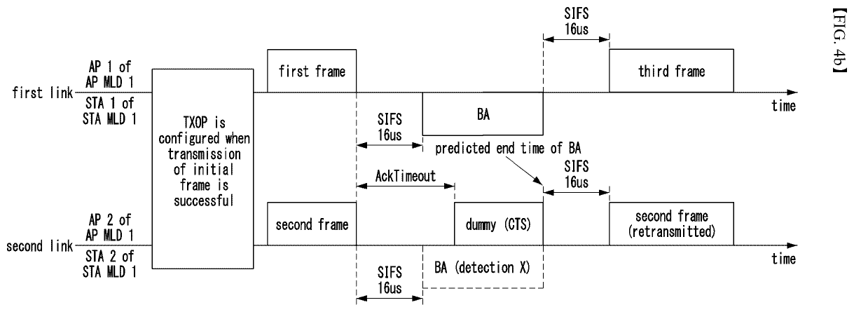

FIG. 4A is a timing diagram illustrating a third exemplary embodiment of an error recovery method in multi-link transmission of an NSTR device.

As shown in FIG. 4A, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The STA 1 may perform initial transmission of a frame (e.g., data frame, uplink frame) on the first link and may receive a reception response frame for the frame. Through the transmission operation of the frame, the STA 1 may configure a TXOP on the first link. In other words, a TXOP may be granted to the STA 1. The STA 1 may be a TXOP holder. The STA 2 may perform initial transmission of a frame (e.g., data frame, uplink frame) on the second link and may receive a reception response frame for the frame. Through the transmission operation of the frame, the STA 2 may configure a TXOP on the second link. In other words, a TXOP may be granted to the STA 2, and the STA 2 may be a TXOP holder.

Frame transmission may be performed multiple times within the TXOP. In other words, if the initial transmission of the frame is successful, the STA 1 and STA 2 may perform multiple frame transmissions within the TXOP. A transmission start time of a frame of the STA 1 on the first link may be synchronized with a transmission start time of a frame of the STA 2 on the second link. A transmission end time of the frame of the STA 1 on the first link may be synchronized with a transmission end time of the frame of the AP 2 on the second link.

On the first link, the STA 1 may transmit a first frame to the AP 1 and receive a reception response frame for the first frame from the AP 1. On the second link, the STA 2 may transmit a second frame to the AP 2 but may not receive a reception response frame for the second frame within an AckTimeout (e.g., aSIFSTime+aSlotTime+aRxPHYStartDelay) from a transmission time of the second frame. In this case (e.g., if preamble detection fails), the STA 2 may transmit a dummy frame. The dummy frame transmitted by the STA 2 may be a CTS frame that includes a receiver address (RA) set to the STA 2. In other words, the dummy frame may be a CTS-to-Self frame. Alternatively, the dummy frame may be a CTS frame transmitted to the AP 2. The dummy frame may also be a frame (e.g., QoS data frame or QoS Null frame) other than a CTS frame.

The dummy frame of the STA 2 may be transmitted until an end time (e.g., predicted end time) of the reception response frame for the second frame. In other words, an end time of the dummy frame may be synchronized with the end time of the reception response frame for the second frame. Alternatively, the dummy frame of the STA 2 may be transmitted until an end time (e.g., predicted end time) of the reception response frame for the first frame on the first link. In other words, the end time of the dummy frame may be synchronized with the end time of the reception response frame for the first frame.

To avoid causing interference with the STA 1 affiliated with the STA MLD 1 (e.g., NSTR STA MLD), the STA 2 may transmit the dummy frame with low power. The dummy frame may be generated based on a low modulation and coding scheme (MCS). The dummy frame with low power may be decoded based on the low MCS.

The end time (e.g., predicted end time) of the reception response frame for the second frame on the second link and/or the end time (e.g., predicted end time) of the reception response frame for the first frame on the first link may be configured between the AP MLD 1 and STA MLD 1 through single response scheduling (SRS). Alternatively, the SRS may not be used. In this case, the STA MLD 1 may predict the end time of the reception response frame based on a traffic identifier (TID) and/or negotiated BA bitmap size.

If preamble detection of the reception response frame on the second link fails, and a channel is determined to be in an idle state by energy detection and/or clear channel assessment (CCA), the STA 2 may transmit the dummy frame. Alternatively, if preamble detection of the reception response frame on the second link fails, and the channel is determined to be in a busy state by energy detection and/or CCA, the STA 2 may transmit the dummy frame. Alternatively, if preamble detection of the reception response frame fails on the second link, the STA 2 may transmit the dummy frame without considering energy detection and/or CCA.

FIG. 4B is a timing diagram illustrating a fourth exemplary embodiment of an error recovery method in multi-link transmission of an NSTR device.

As shown in FIG. 4B, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The AP 1 may perform initial transmission of a frame (e.g., data frame, downlink frame) on the first link and may receive a reception response frame for the frame. Through the transmission operation of the frame, the AP 1 may configure a TXOP on the first link. In other words, a TXOP may be granted to the AP 1. The AP 1 may be a TXOP holder. The AP 2 may perform initial transmission of a frame (e.g., data frame, downlink frame) on the second link and may receive a reception response frame for the frame. Through the transmission operation of the frame, the AP 2 may configure a TXOP on the second link. In other words, a TXOP may be granted to the AP 2. The AP 2 may be a TXOP holder.

Frame transmission may be performed multiple times within the TXOP. In other words, if the initial transmission of the frame is successful, the AP 1 and AP 2 may perform multiple frame transmissions within the TXOP. A transmission start time of a frame of the STA 1 on the first link may be synchronized with a transmission start time of a frame of the STA 2 on the second link. A transmission end time of the frame of the STA 1 on the first link may be synchronized with a transmission end time of the frame of the AP 2 on the second link.

On the first link, the AP 1 may transmit a first frame to the STA 1 and receive a reception response frame for the first frame from the STA 1. On the second link, the AP 2 may transmit a second frame to the STA 2 but may not receive a reception response frame for the second frame within an AckTimeout time (e.g., aSIFSTime+aSlotTime +aRxPHYStartDelay) from a transmission time of the second frame. In this case (e.g., if preamble detection fails), the AP 2 may transmit a dummy frame. The dummy frame transmitted by the AP 2 may be a CTS frame that includes a receiver address (RA) set to the AP 2. In other words, the dummy frame may be a CTS-to-Self frame. Alternatively, the dummy frame may be a CTS frame transmitted to the STA 2. The dummy frame may also be a frame (e.g., QoS data frame or QoS Null frame) other than a CTS frame.

The dummy frame of the AP 2 may be transmitted until an end time (e.g., predicted end time) of the reception response frame for the second frame. In other words, an end time of the dummy frame may be synchronized with the end time of the reception response frame for the second frame. Alternatively, the dummy frame of the AP 2 may be transmitted until an end time (e.g., predicted end time) of the reception response frame for the first frame on the first link. In other words, the end time of the dummy frame may be synchronized with the end time of the reception response frame for the first frame.

The end time (e.g., predicted end time) of the reception response frame for the second frame on the second link and/or the end time (e.g., predicted end time) of the reception response frame for the first frame on the first link may be configured between the AP MLD 1 and STA MLD 1 through SRS. Alternatively, the SRS may not be used. In this case, the AP MLD 1 may predict the end time of the reception response frame based on a TID and/or negotiated BA bitmap size.

If preamble detection of the reception response frame on the second link fails, and a channel is determined to be in the idle state by energy detection and/or clear channel assessment (CCA), the AP 2 may transmit the dummy frame. Alternatively, if preamble detection of the reception response frame on the second link fails, and the channel is determined to be in the busy state by energy detection and/or CCA, the AP 2 may transmit the dummy frame. Alternatively, if preamble detection of the reception response frame fails on the second link, the AP 2 may transmit the dummy frame without considering energy detection and/or CCA.

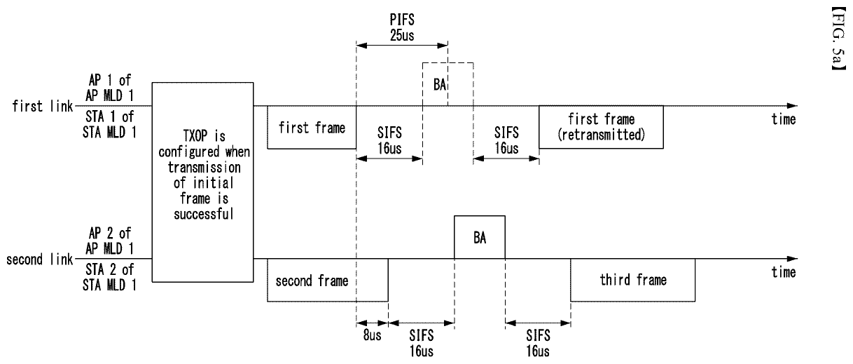

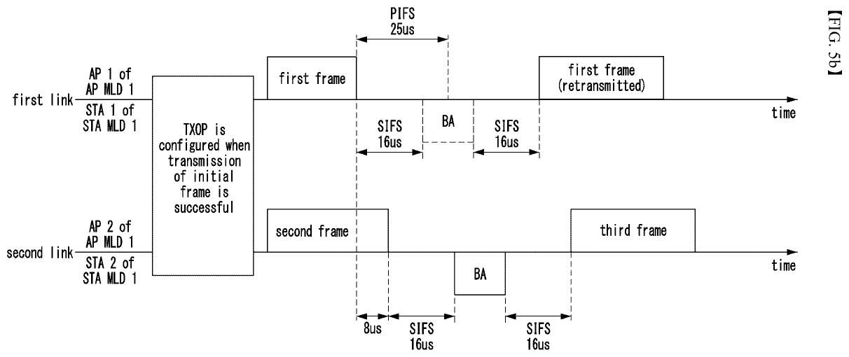

FIG. 5A is a timing diagram illustrating a fifth exemplary embodiment of an error recovery method in multi-link transmission of an NSTR device.

As shown in FIG. 5A, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The STA 1 may perform initial transmission of a frame (e.g., data frame, uplink frame) on the first link and may receive a reception response frame for the frame. Through the transmission operation of the frame, the STA 1 may configure a TXOP on the first link. In other words, a TXOP may be granted to the STA 1. The STA 1 may be a TXOP holder. The STA 2 may perform initial transmission of a frame (e.g., data frame, uplink frame) on the second link and may receive a reception response frame for the frame. Through the transmission operation of the frame, the STA 2 may configure a TXOP on the second link. In other words, a TXOP may be granted to the STA 2. The STA 2 may be a TXOP holder.

Frame transmission may be performed multiple times within the TXOP. In other words, if the initial transmission of the frame is successful, the STA 1 and STA 2 may perform multiple frame transmissions within the TXOP. A time difference between an end time of a first frame transmitted by the STA 1 on the first link and an end time of a second frame transmitted by the STA 2 on the second link may be up to 8 μs. The end time of the first frame transmitted by the STA 1 on the first link may be earlier than the end time of the second frame transmitted by the STA 2 on the second link.

The STA 1 may not receive a reception response frame for the first frame within a preset time (e.g., SIFS) from a transmission time of the first frame. For example, the STA 1 may fail to detect a preamble of a reception response frame for the first frame, and the channel may be determined to be in the busy state by energy detection and/or CCA. In a retransmission procedure for the first frame on the first link, synchronized channel access operations between the first link and the second link may not be possible. Therefore, on the first link, the STA 1 may retransmit the first frame after a preset time (e.g., SIFS) from an end time of the busy state of the channel. Alternatively, after the end time of the busy state of the channel, the retransmission operation of the first frame by the STA 1 and a transmission operation of a third frame by the STA 2 may be synchronized. In other words, a start time of the retransmission of the first frame by the STA 1 may be synchronized with a start time of the transmission of the third frame by the STA 2.

FIG. 5B is a timing diagram illustrating a sixth exemplary embodiment of an error recovery method in multi-link transmission of an NSTR device.

As shown in FIG. 5B, a STA MLD 1 may be an NSTR STA MLD that does not support STR operations. A first link and second link on which the STA MLD 1 operates may be an NSTR link pair. In other words, a STA 1 and STA 2 may be STAs operating on the NSTR link pair. The STA MLD 1 may perform synchronized transmission on multiple links, and an AP MLD 1 may perform synchronized transmission on multiple links for the STA MLD 1 (e.g., NSTR STA MLD). For example, the STA 1 and STA 2 may transmit frames at the same time.

The AP 1 may perform initial transmission of a frame (e.g., data frame, downlink frame) on the first link and may receive a reception response frame for the frame. Through the transmission operation of the frame, the AP 1 may configure a TXOP on the first link. In other words, a TXOP may be granted to the AP 1. The AP 1 may be a TXOP holder. The AP 2 may perform initial transmission of a frame (e.g., data frame, downlink frame) on the second link and may receive a reception response frame for the frame. Through the transmission operation of the frame, the AP 2 may configure a TXOP on the second link. In other words, a TXOP may be granted to the AP 2. The AP 2 may be a TXOP holder.

Frame transmission may be performed multiple times within the TXOP. In other words, if the initial transmission of the frame is successful, the AP 1 and AP 2 may perform multiple frame transmissions within the TXOP. A time difference between an end time of a first frame transmitted by the AP 1 on the first link and an end time of a second frame transmitted by the AP 2 on the second link may be up to 8 μs. The end time of the first frame transmitted by the AP 1 on the first link may be earlier than the end time of the second frame transmitted by the AP 2 on the second link.

The AP 1 may not receive a reception response frame for the first frame within a preset time (e.g., SIFS) from a transmission time of the first frame. For example, the AP 1 may fail to detect a preamble of a reception response frame for the first frame, and the channel may be determined to be in the busy state by energy detection and/or CCA. In a retransmission procedure for the first frame on the first link, synchronized channel access operations between the first link and the second link may not be possible. Therefore, on the first link, the AP 1 may retransmit the first frame after a preset time (e.g., SIFS) from an end time of the busy state of the channel. A start time of the retransmission of the first frame by the AP 1 may be synchronized with a start time of transmission of a third frame by the AP 2. Alternatively, the start time of the retransmission of the first frame by the AP 1 may differ from the start time of the transmission of the third frame by the AP 2. In this case, a difference between the retransmission start time of the first frame and the transmission start time of the third frame may be within a certain time (e.g., 8 μs). The end time of the retransmission of the first frame by the AP 1 may be the same as the end time of the transmission of the third frame by the AP 2. Alternatively, the end time of the retransmission of the first frame by the AP 1 may differ from the end time of the transmission of the third frame by the AP 2. In this case, a difference between the retransmission end time of the first frame and the transmission end time of the third frame may be within a certain time (e.g., 8 μs).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a station (STA) multi-link device (MLD), comprising:
allowing a first STA affiliated with the STA MLD to transmit a first frame to a first access point (AP) affiliated with an AP MLD on a first link;
allowing a second STA affiliated with the STA MLD to transmit a second frame to a second AP affiliated with the AP MLD on a second link;
in response a transmission failure of the first frame, allowing the first STA to retransmit the first frame to the first AP on the first link; and
receiving, from the first AP, a first reception response frame for the first frame on the first link,
wherein the first reception response frame includes first reception status information of the first frame and second reception status information of the second frame.

2. The method according to claim 1, wherein the STA MLD is a non-simultaneous transmit and receive (NSTR) STA MLD that does not support simultaneous transmit and receive (STR) operations, and when retransmission of the first frame causes interference in reception of a second reception response frame for the second frame, the second reception status information is included in the first reception response frame.

3. The method according to claim 1, wherein the first reception response frame includes a first medium access control (MAC) layer protocol data unit (MPDU) including the first reception status information and a second MPDU including the second reception status information.

4. The method according to claim 1, wherein transmission of the first frame and transmission of the second frame are performed simultaneously, and a transmission end time of the first frame is earlier than a transmission end time of the second frame.

5. The method according to claim 1, wherein transmission of the first frame is performed in a first transmit opportunity (TXOP) configured by the first STA, and transmission of the second frame is performed in a second TXOP configured by the second STA.

6. The method according to claim 1, further comprising: allowing the second STA to receive a second reception response frame for the second frame from the second AP on the second link, after the retransmission operation of the first frame ends on the first link.

7. A method of an access point (AP) multi-link device (MLD), comprising:
allowing a first AP affiliated with the AP MLD to transmit a first frame to a first station (STA) affiliated with a STA MLD on a first link:
allowing a second AP affiliated with the AP MLD to transmit a second frame to a second STA affiliated with the STA MLD on a second link:
in response to a transmission failure of the first frame, allowing the first AP to retransmit the first frame to the first STA on the first link; and
receiving, from the first STA, a first reception response frame for the first frame on the first link,
wherein the first reception response frame includes first reception status information of the first frame and second reception status information of the second frame.

8. The method according to claim 7, wherein the STA MLD is a non-simultaneous transmit and receive (NSTR) STA MLD that does not support simultaneous transmit and receive (STR) operations, and when transmission of a second reception response frame for the second frame causes interference in reception of the first frame, the second reception status information is included in the first reception response frame.

9. The method according to claim 7, wherein the first reception response frame includes a first medium access control (MAC) layer protocol data unit (MPDU) including the first reception status information and a second MPDU including the second reception status information.

10. The method according to claim 7, wherein transmission of the first frame and transmission of the second frame are performed simultaneously, and a transmission end time of the first frame is earlier than a transmission end time of the second frame.

11. The method according to claim 7, wherein transmission of the first frame is performed in a first transmit opportunity (TXOP) configured by the first STA, and transmission of the second frame is performed in a second TXOP configured by the second STA.

12. The method according to claim 7. further comprising: allowing the second AP to receive a second reception response frame for the second frame from the second STA on the second link. after the retransmission operation of the first frame ends on the first link.
